(19) United States
(12) Patent Application Publication
(10) Pub. No.: US 2010/0251893 A1
(43) Pub. Date: Oct. 7, 2010

(54) HVAC Register Filter and Method of Using the Same

(76) Inventors: Travis Alan Hamlin, Bakersfield, CA (US); Aaron Lowell Jarrels, Bakersfield, CA (US)

Correspondence Address: KLEIN, DENATALE, GOLDNER, COOPER et. al., P.O. BOX 11172, BAKERSFIELD, CA, 93389-1172, US

(21) Appl. No.: 12/684,849

(22) Filed: Jan. 8, 2010

Related U.S. Application Data
(60) Provisional application No. 61/211,961, filed on Apr. 6, 2009.

(51) Int. Cl. B01D 46/10

(52) U.S. Cl. 95/285; 55/480; 96/222; 95/273

(57) ABSTRACT

A filter is used in combination with a register for an HVAC system, where the register is mounted to a wall, floor, or ceiling. The type of register used in this invention has a plurality of parallel blades which are located on the exterior side of the register and a plurality of vane members set behind the parallel blades, where a space is defined between the parallel blades and the plurality of vane members. The filter has a pliable rectangular frame and a pliable filter material spanning across the pliable rectangular frame. The pliable rectangular frame and pliable filter material allow the filter to be inserted between the blades for placement in the space without removing the register from the wall, floor or ceiling.

Cross-Reference to Related Applications: U.S. Provisional Application No. 61/211,961 was filed on Apr. 6, 2009 for which these inventors claim domestic priority.

### BACKGROUND OF THE INVENTION

The United States Environmental Protection Agency has said that indoor air may be two to five times more polluted than outdoor air. This conclusion raises obvious health concerns, and suggests that appropriate steps should be taken to address this issue. The primary defense mechanism for building occupants is effective filtration utilized in conjunction with the structures HVAC (Heating, Ventilating and Air Conditioning) equipment. The filtration is generally utilized at the inlet to the HVAC system. However, dust, mold or other particulate matter may be present or accumulate in the ducting system, past the inlet filter. Thus these substances may be discharged through the interior outlets of the HVAC system, providing a potential health hazard to the building occupants. One manner of addressing this problem is by filtering the air discharged at the HVAC outlet.

### SUMMARY OF THE INVENTION

There have been efforts to filter the discharged air at the HVAC outlets. The HVAC outlet, often referred to as a register, provides some control of the discharged air. One commonly used register is mounted at the termination of a section of ducting with the register closely or flush mounted with the floor, wall, or ceiling. The register will typically provide some means for controlling the direction and quantity of air flowing through the register and into the room. The typical register comprises a plurality of parallel blades which are mounted on the “exterior” side of the register—that is the side of the register facing into the room. The term “exterior” when utilized with respect to a register, applies this convention—that the exterior side of the register is that facing into the room.

The register also comprises a plurality of vane members disposed behind the parallel blades, where a space is defined between the parallel blades and the plurality of vane members. The blade members are typically fixed, while the vane members are typically adjustable with a slide lever or control knob which extends between the blades for manual access.

Some efforts have been made to filter the air being discharged through the above-described register. However, the known devices have either required that the register be removed from the wall, floor, or ceiling for installation of the filter device, or else have provided means for attaching the filter to the outside edge of the register. The first type of device thus has the inconvenience of having to remove the register, usually requiring tools, for insertion of the filter. Because the filters must periodically be replaced or cleaned, this characteristic presents a significant impediment in the utilization of the devices. The second type of device, which attaches to the outside of the register, solves the problem presented by the first type. However, the second type presents other disadvantages. These devices typically utilize an elastic band or similar device to fit around the outside frame of the register. However, obtaining a secure attachment can be problematic. Moreover, as the filter becomes dirty over time, the pressure drop across the filter might increase to the point to where the filter is either blown off of the register, or dislodged to the point that air is blowing around the filter, defeating its purpose.

The present apparatus resolves the above disadvantages. Embodiments of the disclosed apparatus are used in combination with a register for an HVAC system, where the register is mounted to a wall, floor, or ceiling. The register comprises a plurality of parallel blades which are located on the exterior side of the register and a plurality of vane members set behind the parallel blades, wherein a space is defined between the parallel blades and the plurality of vane members. The filter of the combination comprises a pliable rectangular frame and a pliable filter material spanning across the pliable rectangular frame. The pliable rectangular frame and pliable filter material allow the filter to be inserted between the blades for placement in the space without removing the register from the wall, floor or ceiling. In addition to a non-scented embodiment, embodiments of the present invention may comprise a filter material which has been treated with a fragrance or scent. Thus, when air is forced through the filter into the room, it may be accompanied by a pleasant fragrance.

Various filter materials might be utilized. For example, the filter material may comprise a wire mesh reinforcement member for adding additional strength to the filter. The filter material may also comprise particles of silver which has antiviral properties which inhibit the passage of various bacteria and viruses.

### BRIEF DESCRIPTION OF THE DRAWINGS

FIG. 1 shows a front view of an HVAC register which may be utilized in combination with embodiments of the disclosed filter.

FIG. 2 shows a side view of the HVAC register of FIG. 1 as installed in a wall and connected to ducting.

FIG. 3 schematically shows an embodiment of the disclosed filter.

FIG. 4 shows a cross-section of the filter of FIG. 3 along line 4-4.

FIG. 5 shows a top view of an embodiment of the disclosed filter.

FIG. 6 schematically shows how an embodiment of the disclosed filter may be installed into an HVAC register between the blades of the register.

### DETAILED DESCRIPTION OF THE EMBODIMENTS

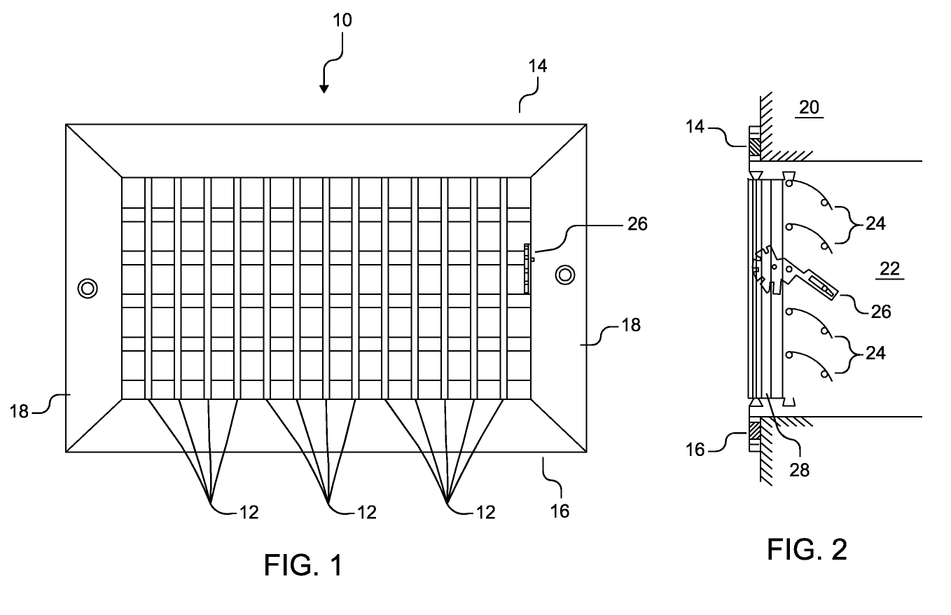

Referring now to the figures, FIGS. 1 and 2 show the type of HVAC register which may be used in combination with the disclosed filter. This type of register 10 the register comprises a plurality of parallel blades 12 which are disposed between an upper frame member 14 and a lower frame member 16, which form, together with side members 18, an exterior frame for the register. This type of HVAC register typically mounts within a wall, floor, or ceiling, with the exterior frame facing outwardly, as shown in FIG. 2, facing into a room. FIG. 2 depicts a register 10 mounted on a wall 20, although it is to be appreciated that the register may also be installed within a floor or ceiling without changing the application of the filter disclosed herein. Register 10 is placed at the termination of ductwork 22. Register 10 further comprises a plurality of vane members 24 which are disposed behind the parallel blades 12. The vane members 24 are often adjustable with an operator 26 which allows the vane members to either be opened wider to allow greater air flow into the room. The vane members are separated from the parallel blades 12 to allow the movement of the vane members. Thus, a space 28 is defined between the parallel blades 12 and the plurality of vane members 24.

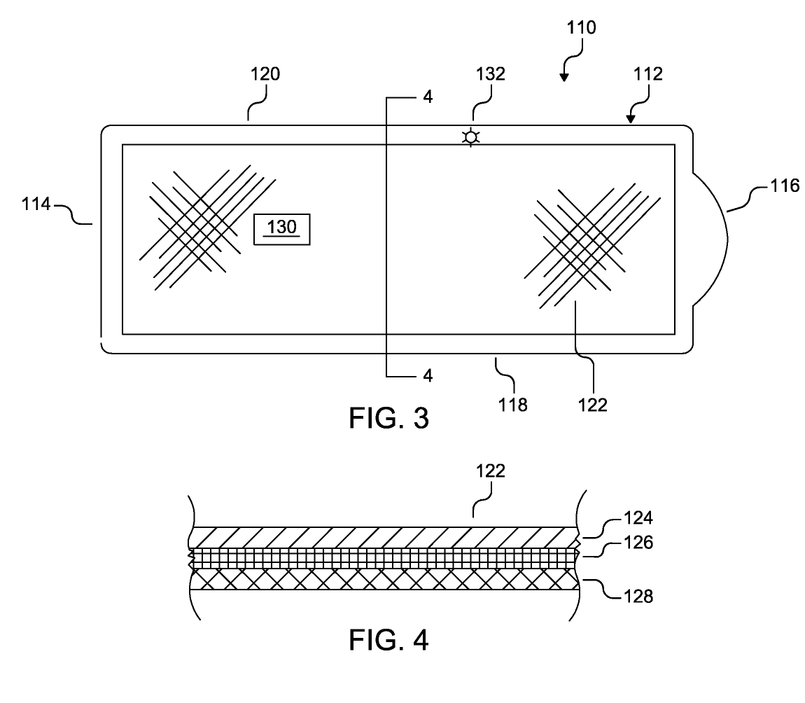

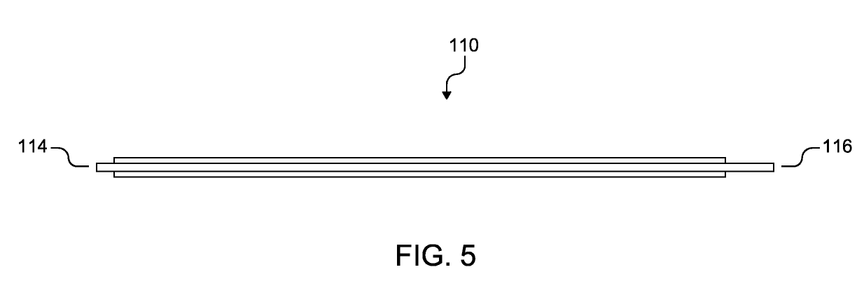

FIGS. 3 through 5 schematically show an embodiment of a filter 110 which might be utilized in combination with register 10. Filter 110 comprises a pliable rectangular frame 112. Rectangular frame 112 comprises a leading edge 114, a trailing edge 116, a bottom edge 118 and a top edge 120. It is to be appreciated that the terms “top” and “bottom” are utilized with reference to FIG. 3 and are of no particular significance with the orientation of the filter 110 in actual usage.

A pliable filter material 122 spans across the pliable rectangular frame 112. The filter material 122 may comprise fiber glass filter cloth, filter fabric, filter cloth, needle felt, polyester and polypropylene air filter cloth, polyester filter felt, or non-woven carbon fabric filter, and any combinations thereof. The filter material 122 may also comprise silver particles. Silver is effective in breaking disulfide bonds which form the structure of various viruses, such that the filter material inactivates various viruses which may be transported through the HVAC ducting system. The filter material may comprise electrostatic properties which capture viruses, bacteria and other particulate matter, such that the filter material immobilizes such matter and prevents its dispersion into the room. As shown in FIG. 4, the filter material 122 may be configured in a laminated configuration, which may combine various materials. For example, the filter material may comprise an exterior layer 124 of woven filter material, an interior layer 126 of an absorbent material, and an exterior layer of a wire mesh reinforcement member 128 for structural integrity. The interior layer of absorbent material 126 may be infused with a fragrance which is dispersed from the filter material by air blown through the filter by the HVAC system blower. For example, the absorbent material 126 may be infused with pine, apple, cinnamon, eucalyptus, rose, or other appealing fragrances. The fragrances may be of the type in which the mobility of the fragrance is enhanced by the application of heat, such as when heated air is blown through the filter 110.

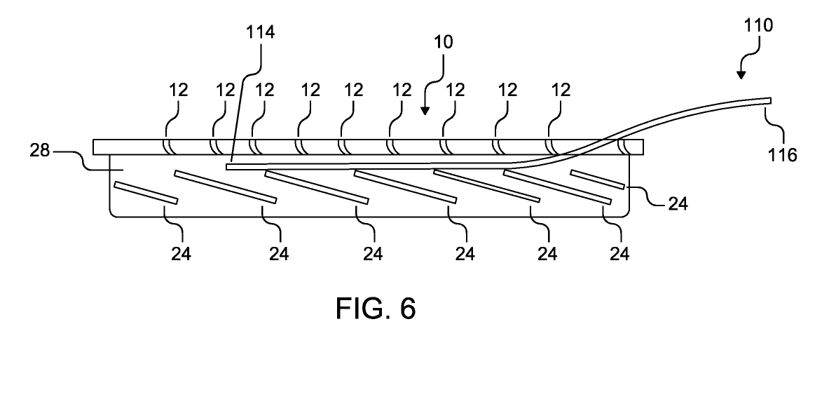

FIG. 6 shows how an embodiment of filter 110 is used in combination with register 10. Unlike other register filters, the filter 110 disclosed herein is constructed such that it may be installed within the register without removing the register from the wall 20, or floor or ceiling as the case may be. As shown in FIG. 6, filter 110 is slid into the space 28 defined by the parallel blades 12 and the plurality of vane members 24, with the leading edge 114 first slid between adjacent parallel blades at one end of the register 10. Filter 110 may be fabricated in such a manner as to facilitate this installation process. For example, leading edge 114 and trailing edge 116 may be fabricated from stiffer material than bottom edge 118 and a top edge 120, such that the bottom edge and top edge flex when being “bent” around one of the blade members, but the stiff leading edge 114 penetrates into the space 28 without excessive deflection. Likewise, the use of stiffer material in the fabrication of trailing edge 116 allows that member to be pushed without having excessive deflection. For example, the leading edge 114 and the trailing edge 116 may be fabricated to have a stiffness which is at least twice the stiffness of the bottom edge 118 and the top edge 120. This greater stiffness may be gained from the use of different materials, or from fabricating the leading edge 114 and trailing edge 116 to have a thickness approximately twice that of the bottom edge 118 and top edge 120. Suitable materials for rectangular frame 112 may comprise cardboard products or thin walled plastic.

Embodiments of the filter 110 may also comprise visual indication means 130 which are preferably placed disposed on the outwardly facing surface of the filter, where the visual indication means indicates when the apparatus should be replaced. For example, a dye which degrades over time may be utilized to provide an indication that the filter has been in use for over a particular period of time, such as thirty days. This indicator, which is visually apparent when looking toward the register, thus provides a notice to the user that it is time to replace the filter. Alternatively, the visual indication means may be connected to a simple circuit which determines the pressure differential across the filter, and which causes the visual indication means to be activated when the pressure differential reaches a predetermined amount. For example, if the pressure at the inwardly facing surface of the filter 110 exceeds the pressure at the outwardly facing surface by 0.25 inches of water, the circuit might cause an LED 132 embedded in the rectangular frame 112 to be illuminated.

The disclosed apparatus may be employed to provide a method for filtering the air stream discharged from a forced air heating, ventilation and air conditioning system, where the system delivers air into a room through a register mounted to a wall, floor, or ceiling. As discussed above, the register 10 comprises a plurality of parallel blades 12 and a plurality of vane members 24 which disposed behind the plurality of parallel blades, such that a space 28 is defined between the plurality of parallel blades and the plurality of vane members. As known with HVAC systems, a blower is utilized for forcing the air through the register into the room. In the method, the blower is preferably turned off, to facilitate installation of the filter. The user then inserts the leading edge 114 of a filter 110 between two adjacent parallel blades 12 of the register 10, at one end of the register. The filter 110 comprises a pliable rectangular frame 112 and a pliable filter material 122 which spans across the pliable rectangular frame. The pliable rectangular frame 112 comprises the leading edge 114 and a trailing edge 116. The user pushes on the trailing edge 116 until substantially all of the filter is disposed in the space between the plurality of parallel blades 12 and the plurality of vane members 24, such that the filter 10 spans substantially the length of the register 10, from one end to the other. When inserted in this manner, the filter 110 covers all of the vane members 24, such that substantially all of the air from the duct work 22 is blown through the filter 110. Once the filter 110 is thus inserted, the blower may be turned back on.

While the above is a description of various embodiments of the present invention, further modifications may be employed without departing from the spirit and scope of the present invention. Thus the scope of the invention should not be limited according to these factors, but according to the following appended claims.

What is claimed is:

1. A filter is used in combination with a register for a heating, ventilation and air conditioning system, the register-filter combination comprising:
a register mounted to a wall, floor, or ceiling, the register comprising a plurality of parallel blades and a plurality of vane members disposed behind the parallel blades, wherein a space is defined between the parallel blades and the plurality of vane members; and
a filter comprising a pliable rectangular frame and a pliable filter material spanning across the pliable rectangular frame, wherein the pliable rectangular frame and pliable filter material allow the filter to be inserted between the blades for placement in the space without removing the register from the wall, floor or ceiling

2. The register-filter combination of claim 1 wherein the filter material comprises a fragrance.

3. The register-filter combination of claim 1 wherein the filter material comprises a wire mesh reinforcement member.

4. The register-filter combination of claim 1 wherein the filter material comprises silver.

5. The register-filter combination of claim 1 wherein the filter material comprises means for immobilizing bacteria.

6. The register-filter combination of claim 1 wherein the filter material is selected from the group consisting of fiber glass filter cloth, filter fabric, filter cloth, needle felt, polyester and polypropylene air filter cloth, polyester filter felt, or non-woven carbon fabric filter, and any combinations thereof.

7. A method for filtering the air stream discharged from a forced air heating, ventilation and air conditioning system which delivers air into a room through a register mounted to a wall, floor, or ceiling, the register comprising a plurality of parallel blades and a plurality of vane members disposed behind the plurality of parallel blades, wherein a space is defined between the plurality of parallel blades and the plurality of vane members, the forced air stream having a blower for forcing the air through the register into the room, the method comprising the following steps:
turning the blower off;
inserting a leading edge of a filter between two adjacent parallel blades, the filter comprising a pliable rectangular frame and a pliable filter material spanning across the pliable rectangular frame, wherein the pliable rectangular frame comprises the leading edge and a trailing edge;
pushing on the trailing edge of the filter until substantially all of the filter is disposed in the space between the plurality of parallel blades and the plurality of vane members; and
turning the blower on.

7. The method of claim 6 wherein the filter material comprises a fragrance.

8. The method of claim 6 wherein the filter material comprises a wire mesh reinforcement member.

9. The method of claim 6 wherein the filter material comprises silver.

10. The method of claim 6 wherein the filter material comprises means for immobilizing bacteria.

11. The method of claim 6 wherein the filter material is selected from the group consisting of fiber glass filter cloth, filter fabric, filter cloth, needle felt, polyester and polypropylene air filter cloth, polyester filter felt, or non-woven carbon fabric filter, and any combinations thereof.

12. In a register unit for a forced air heating, ventilation and air conditioning system, the register unit comprising a plurality of parallel blades and a plurality of vane members disposed behind the parallel blades, wherein a space is defined between the parallel blades and the plurality of vane members, a filter for the register unit comprises:
a frame member comprising a leading edge, a trailing edge, a bottom edge and a top edge, joined at their respective ends to approximately form a rectangle, wherein the leading edge and trailing edge have a stiffness which is at least twice the stiffness of the bottom edge and the top edge; and
a pliable filter material spanning between the leading edge, trailing edge, the bottom edge and the top edge, the pliable filter material comprising an inwardly facing surface through which air enters the filter material and an outwardly facing surface through which air is discharged from the filter material.

13. The filter of claim 12 further comprising a visual indication means disposed on the outwardly facing surface for indicating the apparatus should be replaced.

14. The filter of claim 13 wherein the visual indication means changes colors when pressure at the inwardly facing surface exceeds the pressure at the outwardly facing surface by 0.25 inches of water.

15. The filter of claim 12 wherein the filter material comprises a fragrance.

16. The filter of claim 12 wherein the filter material comprises a wire mesh reinforcement member.

17. The filter of claim 12 wherein the filter material comprises silver.

18. The filter of claim 12 wherein the filter material comprises means for immobilizing bacteria.

19. The filter of claim 12 wherein the filter material is selected from the group consisting of fiber glass filter cloth, filter fabric, filter cloth, needle felt, polyester and polypropylene air filter cloth, polyester filter felt, or non-woven carbon fabric filter, and any combinations thereof.
